(19) United States
(12) Patent Application Publication
(10) Pub. No.: US 2010/0303538 A1
(43) Pub. Date: Dec. 2, 2010

(54) FASTENER COMBINATION INCLUDING A GROOVE AND A NUT

(76) Inventors: Jim Kor, Winnipeg (CA); Tom Hopper, Oak Bluff (CA)

Correspondence Address: ADE & COMPANY INC., 2157 Henderson Highway, WINNIPEG, MB, R2G1P9, CA

(21) Appl. No.: 12/732,342

(22) Filed: Mar. 26, 2010

Related U.S. Application Data
(60) Provisional application No. 61/182,900, filed on Jun. 1, 2009.
(60) Provisional application No. 61/236,357, filed on Aug. 24, 2009.

(51) Int. Cl. F16B 37/00; F16B 9/02

(52) U.S. Cl. 403/22; 411/427

(57) ABSTRACT

A fastener includes an elongate groove with two shoulders each on a respective side of a mouth of the groove and a nut to be located in the groove having a width greater than the width of the mouth so as to define front bearing surfaces to attach to a male threaded member which passes through the mouth to pull the bearing surfaces of the nut against the shoulders. The nut has a width longitudinal of the female hole which is less than the width of the mouth to pass through the mouth with the hole at right angles to the operating position so as to be rotated to turn the hole to the operating position. The nut has a rib along or adjacent a respective side edge of the nut and arranged to engage with a respective groove along a respective shoulder so as to resist outward movement of the shoulders.

This application claims the benefit under 35 U.S.C. 119 from Provisional Application Ser. No. 61/180,900 filed May 25, 2009 and from Provisional Application Ser. No. 61/236,357 filed Aug. 24, 2009.

This application relates to a co-pending application filed on the same day as this application Ser. No TO BE ADDED and relating to the floating dock described herein.

This invention relates to fastener combination including a groove and a nut which is primarily designed for a floating dock but which can be used in other areas than the floating dock.

### SUMMARY OF THE INVENTION

It is one object of the present invention to provide a fastener combination including a mounting body with a groove and a nut which allows a nut to enter the groove from the top and not necessarily from the end.

According to one aspect of the invention there is provided a fastener combination comprising:

a mounting body to which an element is to be fastened;

the mounting body having an elongate groove defining a receptacle therein, the groove having a mouth located at a surface of the mounting body and a receptacle portion behind the mouth, the receptacle portion being wider than the mouth so as to define two shoulders each on a respective side of the mouth;

a nut member having female threaded hole therein, the nut member being shaped and arranged to be located in the groove, the nut member having a width greater than the width of the mouth so as to define front bearing surfaces on each side of the hole for engaging the shoulders, the female threaded hole being located between the bearing surfaces and arranged in an operating position with the hole at right angles to the mouth;

and a fastener member having a male thread thereon shaped and arranged to pass through the mouth and to engage the female threaded hole in the nut member so as to pull the bearing surfaces of the nut member against the shoulders;

the nut member being shaped such that its width in a direction longitudinal of the female threaded hole is less than the width of the mouth so that the nut member can be inserted into the groove through the mouth with the hole at right angles to the operating position and can be rotated in the receptacle portion to turn the hole to the operating position.

Preferably the groove has a base of the receptacle portion opposite the mouth which is smoothly curved and the nut member has a rear surface opposite the bearing surfaces which is smoothly curved.

Preferably the curvature of the rear surface of the nut member is arranged to match the base of the groove.

Preferably both surfaces are semi-cylindrical.

Preferably the front face of the nut member is fiat.

Preferably the groove is substantially continuous along the mounting body and the nut member is short in relation to the mounting body and can be inserted into the mouth at any point along the groove.

Preferably the mounting member and the groove therein are extruded and cut to length.

Preferably the nut member has the bearing surfaces thereof along substantially the full length thereof so as to bear against the shoulders of the groove with an adequate bearing surface so that the nut member becomes a structural part of the groove.

Preferably the nut member has a plurality of threaded holes at spaced positions therealong each for receiving a respective one of a plurality of male threaded fastener members.

Preferably the width of the nut member in the direction along the hole is sufficiently short to provide leeway for a cap screw to go right through the nut with clearance behind the nut member.

Preferably the nut member includes a pair of elements each element being arranged along or adjacent a respective side edge of the nut member and arranged to engage with a respective element along a respective shoulder so as to resist outward movement of the shoulders.

Preferably wherein one of the elements comprises a rib and the other a groove.

Preferably the element on the nut comprises a rib and the element on the shoulder comprises a groove, although this can be arranged the other way round with the rib on the shoulder.

Preferably the rib and the groove are shaped so as to correspond and each tapers to an apex so as to hold the elements interconnected against movement tending to move the shoulders apart.

Preferably the nut includes a pair of grooves one along a center line of the front face and the second along a center line of the rear face to assist drilling of a hole through the center.

According to a second aspect of the invention there is provided a fastener combination comprising:

a mounting body to which an element is to be fastened;

the mounting body having an elongate receiving groove defining a receptacle therein, the groove having a mouth located at a surface of the mounting body and a receptacle portion behind the mouth, the receptacle portion being wider than the mouth so as to define two shoulders each on a respective side of the mouth;

a nut member having female threaded hole therein, the nut member being shaped and arranged to be located in the receiving groove, the nut member having a width greater than the width of the mouth so as to define front bearing surfaces on each side of the hole for engaging the shoulders, the female threaded hole being located between the bearing surfaces and arranged in an operating position with the hole at right angles to the mouth;

and a fastener member having a male thread thereon shaped and arranged to pass through the mouth and to engage the female threaded hole in the nut member so as to pull the bearing surfaces of the nut member against the shoulders;

the nut member being shaped such that its width in a direction longitudinal of the female threaded hole is less than the width of the mouth so that the nut member can be inserted into the receiving groove through the mouth with the hole at right angles to the operating position and can be rotated in the receptacle portion to turn the hole to the operating position;

wherein the nut member includes a pair of elements each element being arranged along or adjacent a respective side edge of the nut member and arranged to engage with a respective element along a respective shoulder so as to resist outward movement of the shoulders.

While the above construction of fastener can be used in many different constructions and arrangements, it is particularly designed for use in a floating dock comprising:

a fabricated frame including a pair of longitudinal side rails and a plurality of cross members interconnecting the side rails to form a rigid generally rectangular structure;

the frame being arranged to receive one of more buoyancy members for floating the frame on a body of water;

a plurality of floor planks for forming a floor surface on the frame to be supported above the water;

each of the side rails being formed of an extruded member.

Preferably each of the side rails is generally rectangular in cross section with an outwardly facing upstanding surface, an inwardly facing upstanding surface, a top surface and a bottom surface and wherein each of the side rails includes a mounting groove formed into at least the top surface, bottom surface and outwardly facing upstanding surface.

Preferably the inwardly facing upstanding surface also includes at least one mounting groove.

Preferably the inwardly facing upstanding surface has two vertically spaced mounting grooves.

Preferably an elongate mounting bracket is connected to the inwardly facing upstanding surface by an upstanding plate of the mounting bracket which is fastened to said at least one mounting groove and wherein the mounting bracket includes an inwardly facing channel portion attached to the plate for receiving an end of floor plank by which a series of floor planks are fastened side by side to the side rail to span the frame.

Preferably a top edge of the channel member includes a flange portion for covering a chamfered edge of the rail at the junction between the inwardly facing upstanding surface and the top surface.

Preferably a top leg of the channel portion is shorter than a bottom leg thereof.

Preferably the outwardly facing upstanding surface has a channel outwardly of the mounting groove within which an elongate member can be received and fastened to the rail by a plurality of fasteners at spaced positions along the rail.

According to a further aspect of the invention there is provided a floating dock comprising:

a fabricated frame including a pair of longitudinal side rails and a plurality of cross members interconnecting the side rails to form a rigid generally rectangular structure;

the frame being arranged to receive one of more buoyancy members for floating the frame on a body of water;

a plurality of floor planks for forming a floor surface on the frame to be supported above the water;

each of the side rails being formed of an extruded member;

wherein each of the side rails is generally rectangular in cross section with an outwardly facing upstanding surface, an inwardly facing upstanding surface, a top surface and a bottom surface;

wherein each of the side rails includes a mounting groove formed into at least the top surface, bottom surface and outwardly facing upstanding surface.

According to a third aspect of the invention there is provided a floating dock comprising:

a fabricated frame including a pair of longitudinal side rails and a plurality of cross members interconnecting the side rails to form a rigid generally rectangular structure;

the frame being arranged to receive one of more buoyancy members for floating the frame on a body of water;

a plurality of floor planks for forming a floor surface on the frame to be supported above the water;

each of the side rails being formed of an extruded member;

wherein each of the side rails is generally rectangular in cross section with an outwardly facing upstanding surface, an inwardly facing upstanding surface, a top surface and a bottom surface;

wherein the inwardly facing upstanding surface includes at least one mounting groove;

wherein an elongate mounting bracket is connected to the inwardly facing upstanding surface by an upstanding plate of the mounting bracket which is fastened to said at least one mounting groove and wherein the mounting bracket includes an inwardly facing channel portion attached to the plate for receiving an end of floor plank by which a series of floor planks are fastened side by side to the side rail to span the frame.

The arrangement described herein provides therefore a special shape or profile for a special nut and aluminum extrusion.

This shape or profile has been designed specifically for the extrusion process, but is not limited to this process of manufacturing (it is expected that 99% of applications will see an extruded groove, and perhaps 50% of applications will see an extruded shape used to make the nut, the other 50% being a nut manufactured by either forging, machining, or similar process). Extruded shapes will likely be made of aluminum, although the invention can be made of any material (plastic, steel, aluminum, stainless steel, brass, etc.).

The arrangement described herein deals with dimensional relationship between the nut and groove. The dimensions must be related in a certain way in order for the invention to work correctly. The dimensions can also be related to a standard hex nut, as the dimensions of the special nut and groove can be adjusted so that a standard hex nut also fits the groove (the standard hex nut must enter the groove from the end). This fitting of a standard hex nut is not essential to the invention, but is an important part of the invention (allowing flexibility in applications).

The arrangement described herein is therefore related to the dimensions of the special nut and groove, in section or profile, as they relate to each other. The special nut and groove can be scaled up or down, as required, to match any scale, nut, or thread size, as required by the application.

The primary advantage of this arrangement described herein is that the special nut enters the groove from the top (not necessarily from the end).

A secondary advantage is that this special nut bears on the underside of the groove with an adequate bearing surface so that the special nut becomes a structural part of the extruded groove (a standard nut bears on the underside of the groove with two tiny “half-moon” sections, allowing it to dent the groove under load, and lose tension in the fastener).

A third advantage is that this special nut falls properly in a groove that is oriented horizontal. With grooves in other orientations (vertical, upside down, etc.), a piece of paper can be set in the groove and rotated as the special nut is inserted, allowing the nut to reach proper orientation in the groove (with flat spots facing the underside of the groove).

A fourth advantage is that the special nut can be extruded, and have the thread added wherever required. In other words, bars of “special-nut” shape, of determined length, can be made, with threads added where required. These thread placements can match the article being bolted down. This would make placement of article to be bolted down, relative to special nuts, more convenient and faster. For example, a dock cleat with two holes 4 inches apart can have a mating special-nut bar with threaded holes made 4 inches apart.

A fifth advantage is that the groove uses close to the least material to go from one side of the groove to the other. This is because it is a half-circular shape. This is important in using the least material in extrusions. The half-circular shape is also structurally stronger than a stepped shape, and extrudes better.

A sixth advantage is that the groove shape allows leeway for the cap screw to go right through the nut with clearance. This allows full bearing on the nut threads with standard cap screw lengths. This is lacking in many nut-groove designs that have the cap screw bottom out as soon as the nut thread is cleared (this is problematic in that a cap screw length can rarely be found that provides this exact fit, so in practice full engagement of threads is compromised instead).

### BRIEF DESCRIPTION OF THE DRAWINGS

One embodiment of the invention will now be described in conjunction with the accompanying drawings in which:

FIG. 1 is an end elevational view of an extruded rail showing a fastener combination according to the present invention including the insertion of a nut at one groove and the connection of the fastener to the inserted nut at another one of the grooves.

FIGS. 2, 3 and 4 show various views of the nut for insertion into the grooves of the extruded rail of FIG. 1.

FIG. 5 shows an isometric view of a modified nut for insertion into the grooves of the extruded rail of FIG. 1.

FIG. 6 is a perspective view of a frame for a floating dock including the fastening combination according to the present invention.

FIG. 7 is an isometric view of the extruded rail of one part only of the frame of FIG. 6 showing the fastening of floor planks to the extrusion.

FIG. 8 is an isometric view of the extruded rails of one a corner only of the frame of FIG. 6 showing the fastening of the rails at the corner.

In the drawings like characters of reference indicate corresponding parts in the different figures.

### DETAILED DESCRIPTION

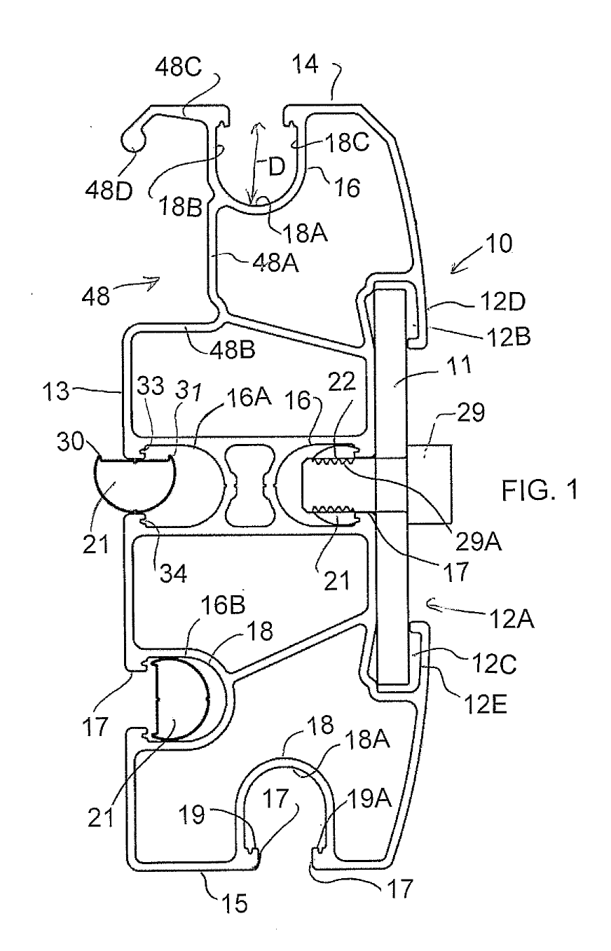

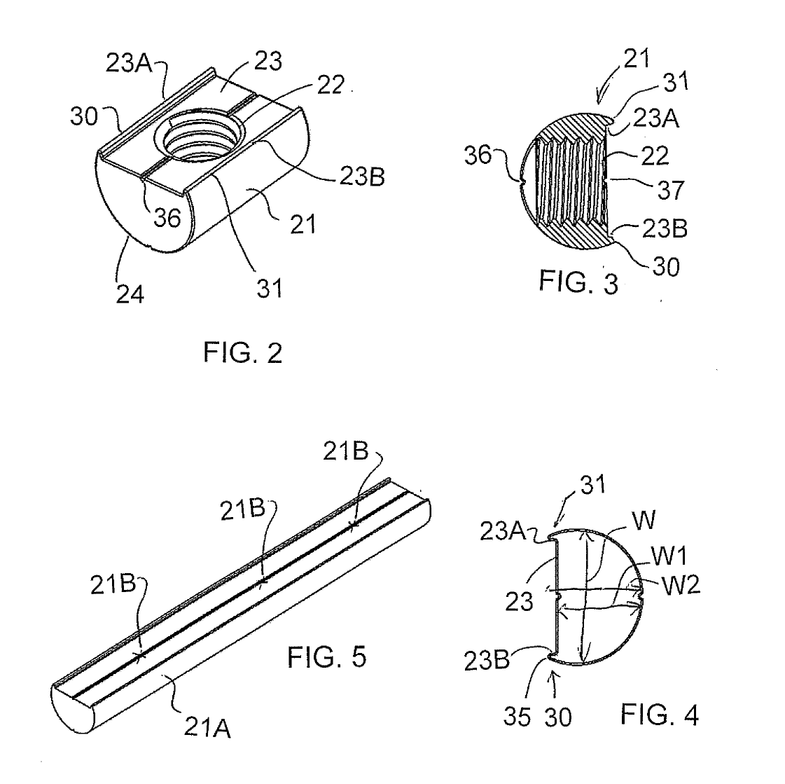

Turning firstly to FIG. 1, this shows a fastener combination comprising a mounting body 10 to which an element 11 is to be fastened. The mounting body 10 is an extruded profile which is generally rectangular in cross section with an outwardly facing upstanding surface 12, an inwardly facing upstanding surface 13, a top surface 14 and a bottom surface 15. The surfaces 14 and 15 are horizontal and the surface 13 is substantially at right angles and vertical. The surface 12 is slightly domed so that its center line extends outwardly from the top and bottom edges.

Each of the top surface, bottom surface and outwardly facing upstanding surface of the extrusion 10 includes a mounting groove or receptacle 16 formed into the surface and recessed inwardly therefrom. The inwardly facing upstanding surface 13 has two vertically spaced mounting grooves 16A and 16B.

Each of the grooves has a mouth 17 located at a surface of the mounting body and a receptacle portion 18 behind the mouth, the receptacle portion being wider 18 than the mouth 17 so as to define two shoulders 19 and 19A each on a respective side of the mouth.

A nut member 21 has a female threaded hole 22 therein. The nut member 21 has a flat front surface 23 and a semi-cylindrical rear surface 24. The hole 22 is located at the center of the flat front face 23 and at right angles to it.

The nut 21 is shaped and arranged to be located in the groove 16 so that the nut member has a width W greater than the width of the mouth 17 so as to define front bearing surfaces 23A and 23B on each side of the hole 22 for engaging the shoulders 19 and 20. The female threaded hole 22 is located between the bearing surfaces 23A and 23B and arranged in an operating position with the hole at right angles to the mouth.

The nut member has the bearing surfaces 23A and 23B thereof along substantially the full length thereof so as to bear against the shoulders 19 and 20 of the groove with an adequate bearing surface so that the nut member becomes a structural part of the groove.

A fastener member 29 has a male thread 29A thereon shaped and arranged to pass through the mouth 17 and to engage the female threaded hole 22 in the nut member 21 so as to pull the bearing surfaces 23A and 23B of the nut member 21 against the shoulders 19A and 19B. The nut member is shaped such that its width W1 in a direction longitudinal of the female threaded hole 22 is less than the width W of the mouth so that the nut member can be inserted into the groove 16 through the mouth 17 with the hole 22 at right angles to the operating position and can be rotated in the receptacle portion to turn the hole to the operating position.

The groove 16 has a base 18A of the receptacle portion 18 opposite the mouth 17 which is smoothly curved which matches the curvature of the rear surface 24 of the nut 21 opposite the bearing surfaces both of which are smoothly curved and preferably semi-cylindrical.

The groove 16 is substantially continuous along the mounting body as it is formed as an extrusion of constant cross section. However other forming techniques may be used so that the groove is not wholly continuous. However the nut member 21 is short in relation to the mounting body so that it can be inserted into the mouth at any point along the groove 16.

The length of the nut is such that it provides sufficient surface contact to allow transfer of the required fastening loads. However double or triple length or more nuts 21A can be used as shown in FIG. 5 which have a plurality of the threaded holes which can be drilled through the longer nut at spaced positions 21B therealong each for receiving a respective one of a plurality of male threaded fastener members. It will be appreciated that no matter the length of the nut it can be readily inserted into the groove at the required location through the mouth rather than from one end.

Preferably the mounting member 10 and the grooves 16 therein are extruded and cut to length and also the nut 21, 21A is similarly extruded and cut to length with the holes 22 drilled in a second action.

The shape of the recessed portion 18 is such that it has sides 18B and 18C which are substantially tangential to the semi-cylindrical base 18A so that the depth D of the groove is greater than the width W1 of the nut 21 giving some clearance behind the nut 21 when it is pulled forwardly to butt the shoulders 19 and 19A. Thus the width W1 of the nut member in the direction longitudinal of the hole 22 is sufficiently short to provide leeway for a cap screw to go right through the nut 21 with clearance behind the semi-circular surface 24.

The nut also includes two male ribs 30 and 31 running along the full length of the flat face 23 of the nut and arranged along the respective side edges or bearing surfaces 23A and 23B of the flat face 23. These male ribs 30 and 31 nest into two matching female grooves 33 and 34 at the shoulders 19 and 19A of the related extruded groove on the extrusion 10.

These two nesting ribs and grooves are not essential to the operation but when provided serve essentially two purposes. They are:

a) The interlocking ribs 30, 31 on the nut and the grooves 33, 34 on the extruded groove 16 strengthen the connection between the nut and extruded groove, essentially locking the two together, when the connection is made and the nut tightened. The extruded groove is weak at its open mouth 17 where the bolt passes through so that the front walls 19 and 19A can easily open further by the mouth 17 spreading apart with applied loads on the extrusion 10 greater than an intended maximum. This is because the semi-circular bottom part 18 of the extruded groove 16 can flex when over-loaded. Tightening the nut 21, in an arrangement without the ribs 30, 31, can causes friction between the nut 21 and extruded groove 16, and this helps by resisting opening of the groove 16 further under load. However, at large enough loads, this clamping force will allow the extruded groove 16 to open up potentially allowing the nut 21 to escape. For this reason, the mating ribs 30, 31 and grooves 33, 34 are added in some cases where higher loads are to be expected. With the ribs and grooves engaged, no opening up of the extruded groove 16 at the mouth 17 is possible. Material would have to shear in order for any relative movement to occur, while without the ribs ad grooves, parts need only to slide for relative movement to occur. The nut 21 and groove 16 are now locked together, not just held together by friction. This is important where increased loads are applied on the extrusion, for whatever reason. This design feature makes the assembled extrusion magnitudes stronger, where required, than it is without the ribs and grooves.

b) The mating ribs and grooves between the nut and extrusion are tapered. That is the side edges of the ribs converge to an upper apex 35. The outer side edge of the rib is contiguous with the outer cylindrical face of the nut and the inner side edge commences at the flat face 23 and converges toward the outer side edge to the smoothly curved apex. This is for two reasons. First, the taper makes sure that the nut always nests properly in the extruded groove. In other words, it does not get hung up. The taper allows the raised male ribs on the face of the nut to always find their way into the female grooves located on the inside face of the extruded groove. This is very important, as the assembler of the system has no way of making sure this will happen. The nut is just slipped into the groove, rotated, and tightened. It must, on its own, find the nested position, and the tapers allow for this to occur. The second reason for the tapers is that it allows the nut to essentially grab the extruded groove during tightening, and then continue to hold on once the assembly is loosened and disassembled. This is a convenience factor. It may be convenient to leave the nuts in position within the groove, as this would speed up reassembly. When required, a light tap on the nut would loosen it from the grooves, and allow it to fall loosely to the bottom of the extruded groove, and be extracted.

The nut, even with the addition of the two male ribs, still can enter the extruded groove from the outside, anywhere along the groove. Entry is accomplished by first putting in one male rib 30, 31 into the extruded groove 16, then rotating the nut 21 slightly to allow entry of the other male rib 30, 31. Without the male ribs, the nut just enters the groove 16 by sliding straight through sideways. Once within the extruded groove, the nut can rotate. The outside of the male ribs added to the nut maintains the circle diameter of the nut, so rotation within the extruded groove is unaffected by the addition of the male ribs. Thus the width W2 from the outside surface 18 of the nut 21 to the plane containing the apexes 60 is thus slightly larger than the width of the mouth 17.

In addition, the nut has two grooves 36 and 37: one centered on the flat face and the other centered on the semicircular back side. These grooves 36 and 37 facilitate holes being drilled in the required centered location, and from either side. Typically the nut 21 is supplied as a blank which are then made in various lengths and the appropriate threaded holes put in place a second process. The blanks can either be extruded aluminum lengths or forged stainless steel lengths. Either way, threaded holes are machined in later, and then the blanks cut to length. Lengths may have one or more threaded holes in them. One typical example is a cleat length which attaches a cleat to the extruded groove 16, and has two threaded holes that match the cleat's spacing. This makes attachment of the cleat more convenient than individual nuts.

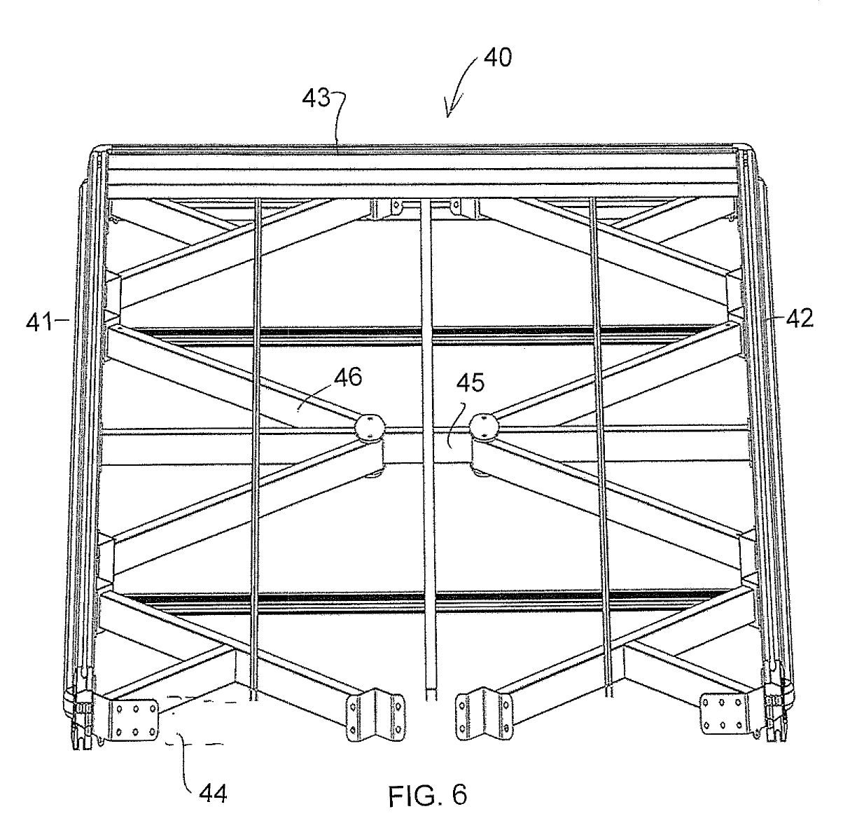

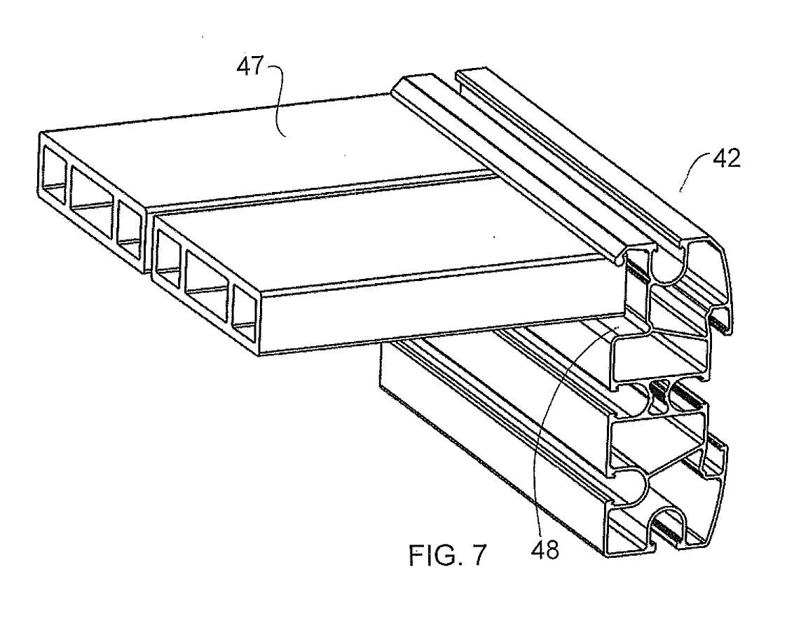

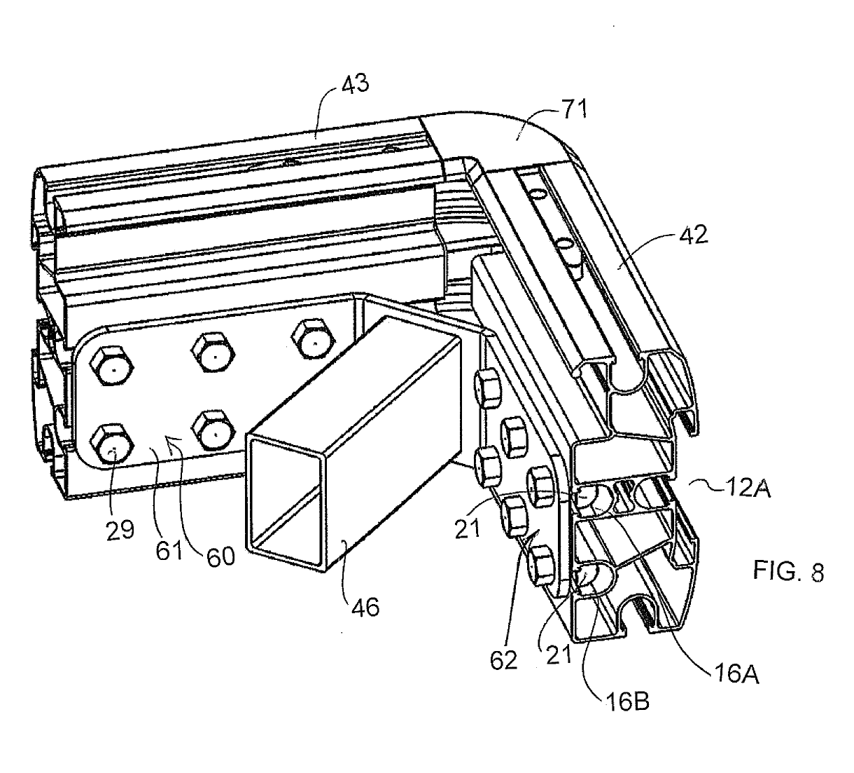

The fastener system described above can be used in many different constructions but is particularly designed for use in the floating dock shown in FIGS. 6, 7 and 8. This includes a fabricated frame 40 including a pair of longitudinal side rails 41 and 42 and a pair of end rails 43 and 44 all of which are formed of the cross sectional shape shown in FIG. 1. These rails are connected at corners as shown in FIG. 8 to form a rigid generally rectangular structure. A plurality of cross rails 45 are provided interconnecting the side rails 41, 42 and braces 46 are provided as stiffening members. The frame is arranged to receive one of more buoyancy members (not shown) underneath the frame for floating the frame on a body of water.

A plurality of floor planks 47 form a floor surface on the frame to be supported above the water. The floor planks 47 are received into a channel 48 formed in the rear surface of the profile 10 as shown in FIG. 1. The channel 48 is located at the upper wall 14 so as to define a rear wall 48A of the recess, a bottom wall 48B and a top wall 48C which extends as a flange from the top wall 14. The space between the bottom wall 48B and a lip 48D at the front edge of the flange or top wall 48C is equal to the thickness of the floor boards 47.

The outwardly facing upstanding surface 12 has a channel 12A outwardly of the mounting groove 16 therein within which an elongate member 11 can be received and fastened to the rail by a plurality of fasteners 29 at spaced positions along the rail using the fastening system described above in the grooves 16. This can form a bumper or other fastener for the rail.

The grooves 16 in the top and bottom surfaces 14, 15 can be used to fasten various elements including deck rails, mounting points for boats and other items well known to a person skilled in this art.

The grooves 16A and 16B are used as shown in FIG. 8 for attachment to brackets 60 at the ends of the braces 46. Thus the bracket 60 includes two legs 61 and 62 each of which includes two rows of fasteners 29 which engage into nuts 21 located within the grooves 16A and 16B in the manner previously described, which are sufficiently long to engage all three fasteners 29 in the groove 16A, 16B. In addition FIG. 8 shows a corner cover 71 which is a cast corner piece which has an end piece bridging the extrusions at the corner and including insert legs which are a tight fit into the ends of the extrusions 42, 43 to close off the corner.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A fastener combination comprising:
a mounting body to which an element is to be fastened;
the mounting body having an elongate groove defining a receptacle therein, the groove having a mouth located at a surface of the mounting body and a receptacle portion behind the mouth, the receptacle portion being wider than the mouth so as to define two shoulders each on a respective side of the mouth;
a nut member having female threaded hole therein, the nut member being shaped and arranged to be located in the groove, the nut member having a width greater than the width of the mouth so as to define front bearing surfaces on each side of the hole for engaging the shoulders, the female threaded hole being located between the bearing surfaces and arranged in an operating position with the hole at right angles to the mouth;
and a fastener member having a male thread thereon shaped and arranged to pass through the mouth and to engage the female threaded hole in the nut member so as to pull the bearing surfaces of the nut member against the shoulders;
the nut member being shaped such that its width in a direction longitudinal of the female threaded hole is less than the width of the mouth so that the nut member can be inserted into the groove through the mouth with the hole at right angles to the operating position and can be rotated in the receptacle portion to turn the hole to the operating position.

2. The combination according to claim 1 wherein the groove has a base of the receptacle portion opposite the mouth which is smoothly curved and the nut member has a rear surface opposite the bearing surfaces which is smoothly curved.

3. The combination according to claim 1 wherein the curvature of the rear surface of the nut member is arranged to match the base of the groove.

4. The combination according to claim 3 wherein the base of the groove and the rear surface are both semi-cylindrical.

5. The combination according to claim 1 wherein the front face of the nut member is flat.

6. The combination according to claim 1 wherein the groove is substantially continuous along the mounting body and the nut member is short in relation to the mounting body and can be inserted into the mouth at any point along the groove.

7. The combination according to claim 1 wherein the mounting member and the groove therein are extruded and cut to length.

8. The combination according to claim 1 wherein the nut member has the bearing surfaces thereof along substantially the full length thereof so as to bear against the shoulders of the groove with an adequate bearing surface so that the nut member becomes a structural part of the groove.

9. The combination according to claim 1 wherein the nut member has a plurality of threaded holes at spaced positions therealong each for receiving a respective one of a plurality of male threaded fastener members.

10. The combination according to claim 1 wherein the width of the nut member in the direction along the hole is sufficiently short to provide leeway for a cap screw to go right through the nut member with clearance behind the nut member.

11. The combination according to claim 1 wherein the nut member includes a pair of elements each element being arranged along or adjacent a respective side edge of the nut member and arranged to engage with a respective element along a respective shoulder so as to resist outward movement of the shoulders.

12. The combination according to claim 11 wherein one of the elements comprising a rib and the other a groove.

13. The combination according to claim 12 wherein the element on the nut comprises a rib and the element on the shoulder comprises a groove.

14. The combination according to claim 13 wherein the rib and the groove taper to an apex.

15. The combination according to claim 1 wherein the nut includes a pair of grooves with one along a center line of the front face and the second along a center line of the rear face to assist drilling of a hole through the center.

16. A fastener combination comprising:
a mounting body to which an element is to be fastened;
the mounting body having an elongate receiving groove defining a receptacle therein, the groove having a mouth located at a surface of the mounting body and a receptacle portion behind the mouth, the receptacle portion being wider than the mouth so as to define two shoulders each on a respective side of the mouth;
a nut member having female threaded hole therein, the nut member being shaped and arranged to be located in the receiving groove, the nut member having a width greater than the width of the mouth so as to define front bearing surfaces on each side of the hole for engaging the shoulders, the female threaded hole being located between the bearing surfaces and arranged in an operating position with the hole at right angles to the mouth;
and a fastener member having a male thread thereon shaped and arranged to pass through the mouth and to engage the female threaded hole in the nut member so as to pull the bearing surfaces of the nut member against the shoulders;
the nut member being shaped such that its width in a direction longitudinal of the female threaded hole is less than the width of the mouth so that the nut member can be inserted into the receiving groove through the mouth with the hole at right angles to the operating position and can be rotated in the receptacle portion to turn the hole to the operating position;
wherein the nut member includes a pair of elements each element being arranged along or adjacent a respective side edge of the nut member and arranged to engage with a respective element along a respective shoulder so as to resist outward movement of the shoulders.

17. The combination according to claim 16 wherein one of the elements comprising a rib and the other a groove.

18. The combination according to claim 17 wherein the element on the nut comprises a rib and the element on the shoulder comprises a groove.

19. The combination according to claim 16 wherein the rib and the groove taper to an apex.
